(19) United States
(12) Patent Application Publication
(10) Pub. No.: US 2026/0189337 A1
(43) Pub. Date: Jul. 2, 2026

(54) INTERFERENCE MITIGATION PILOT DESIGN

(71) Applicant: NXP USA, Inc., AUSTIN, TX (US)

(72) Inventors: Priyanka Bansal, Lakheri (IN); Hari Ram Balakrishnan, Chennai (IN); Rui Cao, Sunnyvale, CA (US); Kapil Gulati, Sunnyvale, CA (US)

(21) Appl. No.: 19/433,710

(22) Filed: Dec. 27, 2025

(30) Foreign Application Priority Data
Dec. 31, 2024 (IN) 202441104880

(51) Int. Cl. H04L 5/00

(52) U.S. Cl. CPC H04L 5/0048

(57) ABSTRACT

A wireless communication system, apparatus, and methodology are described for enabling wireless communication devices to generate IM pilot subcarriers for a PPDU by providing one or more interference mitigation (IM) pilot spacing input parameters to a LDPC tone mapper, where the one or more IM pilot spacing input parameters specify an input IM pilot design with a plurality of IM pilots that are grouped into one or more clusters of IM pilots and specify an offset value for each cluster of IM pilot, and then generating the PPDU that includes a resource unit (RU) or multi-RU (MRU), wherein the LDPC tone mapper processes the one or more IM pilot spacing parameters to identify a disjoint set of IM pilot subcarriers that are substantially uniformly space within the PPDU.

### CROSS-REFERENCE TO RELATED APPLICATION AND PRIORITY CLAIM

This application claims the priority and benefit of India Provisional Patent Application Serial No. 202441104880, entitled “Interference Mitigation Pilot Design” filed on Dec. 31, 2024, the contents of which are incorporated herein by reference in their entirety as if fully set forth herein and made part of the present U.S. Utility Patent Application for all purposes.

### BACKGROUND

### Field

The present disclosure is directed in general to communication networks. In one aspect, the present disclosure relates generally to wireless local area network (WLAN) implementing the Institute of Electrical and Electronics Engineers (IEEE) 802.11 standard and any other standards and/or networks that can provide wireless transfer of data.

### Description of the Related Art

The rapid expansion of wireless communication technologies, particularly within the unlicensed spectrum governed by standards such as IEEE 802.11 (Wi-Fi), has led to increasingly complex and dense operational environments. To support the growing demand for Ultra High Reliability (UHR) and improved performance in heavily congested areas, advanced protocols are being developed. A key feature in the forthcoming 802.11bn protocol is the introduction of Interference Mitigation (IM) pilots. These pilots provide a crucial mechanism to facilitate advanced interference cancellation and enhanced channel estimation in environments where signals from multiple, non-cooperating Basic Service Sets (BSSs) frequently overlap in both time and frequency. In particular, the 802.11bn protocol proposes to insert specialized IM pilots into a Physical Layer Convergence Procedure (PLCP) Protocol Data Unit (PPDU) to enable receiver-side processing. The primary function of these pilots is to allow a receiving station (STA) to estimate the statistics of the overlapping interfering signal. Once the interference statistics, such as the covariance of the interfering signal, are estimated, the receiver attempts to suppress the interference as much as possible. This suppression is typically achieved by performing operations such as a receiver-side equalizer or other techniques that project the desired signal orthogonal to the estimated interference direction. For optimal or near-optimal performance of this interference cancellation technique, the IM pilots are generally desired to be substantially equi-spaced with a uniform distribution across the available frequency tones.

A significant drawback of traditional approaches for implementing these equi-spaced IM pilots lies in the resulting need for creating new tone plans for all combinations of the resource unit (RU) sizes supported with existing protocols such as 802.11be and 802.11bn. When considering the various combinations of these existing RU sizes and the subcarrier placements within them, the mandate to introduce uniformly spaced IM pilots and then adjust the remaining data tones for every single combination becomes intractable. If interference mitigation pilots were to be added for each and every combination of supported RU sizes, a prohibitive number of additional tone plans would need to be defined and standardized. This proliferation of tone plans introduces substantial complexity into the system design, implementation, and overall management of frequency resource allocation. As seen from the foregoing, the existing approaches for adding IM pilots to PPDU structures require the generation and standardization of a unique tone plan for every possible combination of Resource Unit sizes supported by the wireless communication protocols.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a simplified block diagram of a wireless communications system in accordance with selected embodiments of the present disclosure.

FIG. 2A illustrates a first interference mitigation pilot distribution grouping design having a single cluster for input to an LDPC tone mapper in accordance with selected embodiments of the present disclosure.

FIG. 2B illustrates a first distribution of interference mitigation pilots that are spread across a specified bandwidth with a substantially uniformly spacing by an LDPC tone mapper in response to the first interference mitigation pilot distribution grouping of FIG. 2A in accordance with selected embodiments of the present disclosure.

FIG. 3A illustrates a second interference mitigation pilot distribution grouping design having two clusters for input to an LDPC tone mapper in accordance with selected embodiments of the present disclosure.

FIG. 3B illustrates a second distribution of interference mitigation pilots that are spread across a specified bandwidth with a substantially uniformly spacing by an LDPC tone mapper in response to the second interference mitigation pilot distribution grouping of FIG. 3A in accordance with selected embodiments of the present disclosure.

FIG. 4A illustrates a third interference mitigation pilot distribution grouping design having four clusters for input to an LDPC tone mapper in accordance with selected embodiments of the present disclosure.

FIG. 4B illustrates a third distribution of interference mitigation pilots that are spread across a specified bandwidth with a substantially uniformly spacing by an LDPC tone mapper in response to the third interference mitigation pilot distribution grouping of FIG. 4A in accordance with selected embodiments of the present disclosure.

FIG. 5A illustrates a fourth interference mitigation pilot distribution grouping design which includes a first IM pilot cluster with adjacent IM pilot subcarriers and a second IM pilot cluster with alternating IM pilot and data subcarriers in accordance with selected embodiments of the present disclosure.

FIG. 5B illustrates a fourth distribution of interference mitigation pilots that are spread across a specified bandwidth with a substantially uniformly spacing by an LDPC tone mapper in response to the fourth interference mitigation pilot distribution grouping of FIG. 5A in accordance with selected embodiments of the present disclosure.

FIG. 6A illustrates a fifth interference mitigation pilot distribution grouping design which includes a four IM pilot clusters for input to an LDPC tone mapper in accordance with selected embodiments of the present disclosure.

FIG. 6B illustrates a fifth distribution of interference mitigation pilots that are spread across a specified bandwidth with a substantially uniformly spacing by an LDPC tone mapper in response to the fifth interference mitigation pilot distribution grouping of FIG. 6A in accordance with selected embodiments of the present disclosure.

FIG. 7 which depicts a table of IM pilot design parameters for different bandwidth and RU sizes in accordance with selected embodiments of the present disclosure.

FIG. 8 is a table listing of adjusted Nsd, short values for different RU and MRU sizes in accordance with selected embodiments of the present disclosure.

FIG. 9 illustrates an IM pilot encoding system wherein a LDPC tone mapper encodes or maps an input set of one or more IM pilot clusters into a disjoint set of pilot subcarriers that are substantially uniformly distributed across a specified bandwidth for transmission in a PPDU by a wireless device in accordance with selected embodiments of the present disclosure.

FIG. 10 illustrates a flow diagram of a technique for wireless communications in accordance with selected embodiments of the present disclosure.

### DETAILED DESCRIPTION

A system, apparatus, and methodology are described for enabling wireless communication station (STA) devices to wirelessly communicate in accordance with Interference Mitigation (IM) pilots requirements provided for orthogonal frequency-division multiplexing (OFDM) modulated symbols supported by emerging 802.11 standards, such as 802.11bn, by providing input interference mitigation (IM) pilot designs which group one or more clusters of IM pilots as an input to a Low-Density Parity-Check (LDPC) tone mapper with a specified spacing and offset for each cluster so that the LDPC tone mapper generates a Physical Layer Protocol Data Unit (PPDU) in which interference mitigation pilot tones of a resource unit (RU) are substantially uniformly distributed onto a disjoint set of subcarriers included in a larger signal bandwidth using a defined data/pilot tone mapping plan, and transmitting the PPDU using the disjoint set of subcarriers. In selected embodiments, a first input IM pilot design includes a single cluster of IM pilots with a defined offset or “delta” value, where the single cluster of IM pilots can be appended at the beginning or the end of data tones for input to the LDPC tone mapper. In other selected embodiments, a second input IM pilot design includes two clusters of IM pilots, where the beginning of each cluster is separated by a distance d=Nsd/2 and where each cluster has a defined offset or “delta” value. As understood by those skilled in the art, Nsd is defined as the number of data subcarriers in an Orthogonal Frequency-Division Multiplexing (OFDM) symbol, and is a fundamental parameter used to calculate the number of data bits that can be carried in a single symbol. In other selected embodiments, a third input IM pilot design includes four clusters of IM pilots, where the beginning of each cluster is separated by a distance d=Nsd/4 and where each cluster has a defined offset or “delta” value. In other selected embodiments, a fourth input IM pilot design includes first and second clusters of IM pilots, where the beginning of the first cluster is separated from the beginning of the second cluster by a distance d=Nsd/2, where the first and second clusters each have a defined offset or “delta” value, where the first cluster has adjacent IM pilot tones, and where the second cluster has alternating IM pilot tones. In other selected embodiments, a first input IM pilot design includes a single cluster of IM pilots passed through a LDPC tone mapper with an output subcarrier index having an offset or “delta” value, where the single cluster of IM pilots can be appended at the beginning or the end of data tones for input to the LDPC tone mapper. In other selected embodiments, a second input IM pilot design includes two clusters of IM pilots, where the beginning of each cluster is separated by a distance d=Nsd/2 and passed through a LDPC tone mapper with an output subcarrier index having a defined offset or “delta” value. In other selected embodiments, a third input IM pilot design includes four clusters of IM pilots, where the beginning of each cluster is separated by a distance d=Nsd/4 and passed through a LDPC tone mapper with an output subcarrier index having a defined offset or “delta” value. In other selected embodiments, a fourth input IM pilot design includes first and second clusters of IM pilots, where the beginning of the first cluster is separated from the beginning of the second cluster by a distance d=Nsd/2 and passed through a LDPC tone mapper with an output subcarrier index having a defined offset or “delta” value. As disclosed herein, the LDPC tone mapper distributes a plurality of logical RUs over a spreading frequency block such that the IM pilot tones from the input IM pilot design are uniformly distributed across the spreading frequency block.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

References throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

As indicated above, the mapping of IM pilots into a tone plan in the 802.11bn protocol must balance the need for uniformly spaced pilots (optimal for channel and interference estimation) with the complexity of supporting numerous Resource Unit (RU) sizes inherited from 802.11be and 802.11ax. To address the key challenge of avoiding a new tone plan for every RU size combination, the ongoing efforts to refine the 802.11bn protocol employs a system that defines the pilot locations without completely redefining the existing OFDM Resource Unit (RU) layouts. An important requirement for effective interference cancellation is that the IM pilots must be equi-spaced and uniformly distributed across the tones of the transmitted signal. This uniform spacing is essential for the receiver's equalizer or processor to accurately model the interference covariance across the entire frequency band of the transmission. Instead of pre-defining a static tone plan for every possible RU_{SIZE} x Bandwidth combination, the 802.11bn protocol employs an efficient IM pilot tone plan generator which uses a generic rule for placing the equi-spaced IM pilots based on a predetermined sequence or pattern that ensures the desired uniform spacing, regardless of the RU's size or position within the overall channel bandwidth (e.g., 20 MHz, 40 MHz, etc.). Rather than using on a lookup table, the system relies on formulaic pilot insertion which allows the wireless STA to calculate the position of the IM pilots based on the RU's frequency start index and its size, thereby eliminating the need to define additional tone plans for every combination.

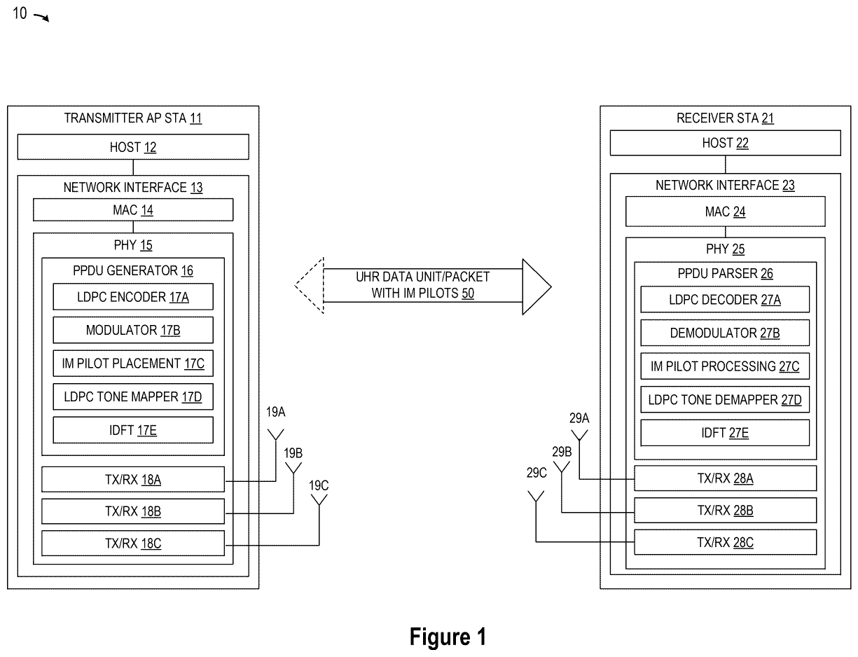

To provide an improved understanding of selected embodiments of the present disclosure, reference is now made to FIG. 1 which depicts a block diagram of a wireless local area network (WLAN) 10 in which wireless communication station (STA) devices 11, 21 transmit Ultra High Reliability (UHR) data units or packets 50 which include IM pilots. In selected embodiments, the UHR data units or packets 50 can be formatted as physical layer protocol data units (PPDU). As depicted, the transmitter station 21 includes a host processor 12 coupled to a network interface 13. As will be appreciated, the host processor 12 may include a processor configured to execute machine readable instructions stored in a memory device (not shown), e.g., random access memory (RAM), read-only memory (ROM), a flash memory, or other storage device. In selected embodiments, the network interface 13 includes one or more integrated circuits (IC) devices configured to operate a local area network (LAN) protocol. To this end, the network interface 13 may include a medium access control (MAC) processor 14 and a physical layer (PHY) processor 15. In selected embodiments, the MAC processor 14 is implemented as an 802.11bn MAC processor 14, and the PHY processor 15 is implemented as an 802.11bn PHY processor 15. The PHY processor 15 includes a plurality of transceivers 18A-C which are coupled to a plurality of antennas 19A-C. Although three transceivers 18A-C and three antennas 19A-C are illustrated, the transmitter station 21 may use any suitable number of transceivers 18 and antennas 19 in other embodiments. Each of transceivers 18A-C includes a transmitter signal path and a receiver signal path, e.g., mixed-signal circuits, analog circuits, and digital signal processing circuits for implementing radio frequency and digital baseband functionality. PHY processor 15 includes at least one amplifier (e.g., low noise amplifier or power amplifier), data converter, and circuits that perform discrete Fourier transform (DFT), inverse discrete Fourier transform (IDFT), modulation, and demodulation. In addition, the transmitter station 21 may have more antennas 19 than transceivers 18, in which case antenna switching techniques are used to switch the antennas 19 between the transceivers 18. In selected embodiments, the MAC processor 14 is implemented with one or more integrated circuit (IC) devices, and the PHY processor 15 is implemented on one or more additional IC devices. In other embodiments, at least a portion of the MAC processor 14 and at least a portion of the PHY processor 15 are implemented on a single IC device. In various embodiments, the MAC processor 14 and the PHY processor 15 are configured to operate according to at least a first communication protocol (e.g., 802.11bn). In other embodiments, the MAC processor 14 and the PHY processor 15 are also configured to operate according to one or more additional communication protocols (e.g., according to the IEEE 802.11be standard). Using the communication protocol(s), the transmitter station 21 is operative to create a wireless local area network (WLAN) 10 in which one or more client receiver stations (e.g., 21) may communicate with the transmitter station 21 and/or with other client stations (not shown) located within the WLAN 10. Although a single client station 21 is illustrated in FIG. 1, the WLAN 10 may include any suitable number of client stations in various scenarios and embodiments.

As depicted, the wireless client receiver station 21 includes a host processor 22 coupled to a network interface 23. In selected embodiments, the network interface 23 includes one or more IC devices configured to operate as discussed below. For example, the depicted network interface 23 may include a MAC processor 24 and a PHY processor 25. In selected embodiments, the MAC processor 24 is implemented as an 802.11bn MAC processor 24, and the PHY processor 25 is implemented as an 802.11bn PHY processor 25. The PHY processor 25 includes a plurality of transceivers 28A-C coupled to a plurality of antennas 29A-C. Although three transceivers 28A-C and three antennas 29A-C are illustrated, the receiver station 21 may include any suitable number of transceivers 28 and antennas 29. In addition, the client receiver station 21 may include more antennas than transceivers, in which case antenna array switching techniques are used. In selected embodiments, the MAC processor 24 is implemented on at least a first IC device, and the PHY processor 25 is implemented on at least a second IC device. In other embodiment, at least a portion of the MAC processor 24 and at least a portion of the PHY processor 25 are implemented on a single IC device.

In operation, the transmitter station 11 is configured to transmit or exchange UHR data units or packets 50 with the receiver station 21 by using beamforming with antenna arrays 19 to compensate for the high pathloss. To this end and as described more fully hereinbelow, each transmitting device (e.g., transmitter station 11) includes a PPDU generator module 16 in the PHY processor 15 which is configured to generate a PPDU 50. In particular, the PPDU generator module 16 may be configured to perform a sequence of transmitter processing steps in the IEEE 802.11bn (UHR) protocol, including but not limited to a Low-Density Parity-Check (LDPC) encoding step 17A, one or more modulation steps 17B, an IM pilot placement step 17C, an LDPC tone mapping step 17D, an Inverse Discrete Fourier Transformation (IDFT) step 17E, along with one or more additional output processing steps. As depicted, the LDPC encoder module 17A may be connected and configured to pass scrambled data bits through an LDPC encoder to perform forward error correction encoding to generate encoded data for the PPDU. In addition, the depicted modulator module 17B may be connected and configured to perform additional processing steps, such as post-FEC padding, stream parsing, and constellation mapping. In addition, and as described more fully hereinbelow, the depicted IM pilot placement module 17C may be connected and configured to generate a group of one or more IM pilot clusters pursuant to a specified IM pilot design for input to the LDPC tone mapper module 17D. In selected embodiments, each specified IM pilot design defines a number clusters of IM pilots (Ncluster) where each cluster may have a defined offset or “delta” value and where multiple clusters are spaced apart by a specified separation distance distance d=Nsd/Ncluster. In addition, the depicted LDPC tone mapper module 17D may be connected and configured to distribute or map the received group of one or more IM pilot clusters and data tones for a plurality of logical RUs over a spreading frequency block using a generic rule for placing the equi-spaced IM pilots based on a predetermined sequence or pattern that ensures the desired uniform spacing, regardless of the RU's size or position within the overall channel bandwidth (e.g., 20 MHz, 40 MHz, etc.). In addition, the depicted IDFT module 17E may be connected and configured to transform the input frequency-domain signal (the symbols on the subcarriers) into a time-domain OFDM symbol.

In similar fashion, the client receiver station 21 is configured to transmit or exchange UHR data units or packets 50 with the transmitter station 11 by using beamforming with antenna arrays 29 to compensate for the high pathloss. To this end and as described more fully hereinbelow, the client receiver station 21 includes a PPDU parser module 26 which configured to perform a sequence of transmitter processing steps in the IEEE 802.11bn (UHR) protocol, including but not limited to an LDPC decoding step 27A, one or more demodulation steps 27B, an IM pilot processing step 27C, an LDPC tone demapping step 27D, an IDFT step 27E, along with one or more additional output processing steps. The functionality of the LDPC decoder module 27A, demodulator module 27B, IM pilot processing module 27C, LDPC tone demapper module 27D, and IDFT module 27E is to reverse the functionality of the LDPC encoder module 17A, modulator module 17B, IM pilot placement module 17C, LDPC tone mapper module 17D, and IDFT module 17E in the transmitter station 11, and will not be repeated here in the interest of brevity.

In accordance with selected embodiments of the present disclosure, a technique for wireless communications may involve generating a PPDU that includes a resource unit (RU), wherein a size of the RU is less than a signal bandwidth. When the transmitter station 11 generates the UHR PPDU 50, the MAC processor 14 generates MAC Protocol Data Units (MPDUs) as MAC layer data that is delivered to PPDU generator 16 in the PHY processor 15. After padding the received MAC layer data with pre-FEC padding alignment bits and performing scrambling to whiten the data, the LDPC encoder 17A performs Forward Error Correction (FEC) processing on the scrambled data bits to add parity bits to the data, significantly increasing the robustness against channel errors. After padding the FEC encoded bits with post-FEC padding alignment bits, the modulator 17B performs parsing and constellation mapping on the padded, encoded data to generate complex-valued symbols according to the specified modulation order (e.g., BPSK, QPSK, 16-QAM, 64-QAM, 256-QAM, etc.) to be transmitted on the data tones corresponding to an RU in the PPDU. In addition, the IM pilot placement module 17C generates a group of one or more IM pilot clusters pursuant to a specified IM pilot design for input to the LDPC tone mapper module 17D. Stated another way, the IM pilot placement module 17C generates IM pilot designs by dividing a set of IM pilots into different clusters or groups for input to the LDPC tone mapper, where each cluster or group can have an offset “delta” value. Functionally, the LDPC tone mapper module 17D acts as a powerful permutation (reordering) block that rearranges the complex-valued symbols coming from the modulator 17B (e.g., Constellation Mapper(s)) and the IM pilot placement module 17C. In particular, the LDPC tone mapper 17D distributes adjacent coded bits (which are now grouped into symbols) onto non-adjacent OFDM subcarriers in the frequency domain to ensure that a localized deep fade or strong burst of noise on a few subcarriers does not wipe out an entire block of consecutive coded bits, which would severely degrade the performance of the LDPC decoder at the receiver. This is a key feature for achieving Ultra High Reliability (UHR).

As disclosed herein, the specified IM pilot designs could be used for 26, 52, 52+26, 106, 106+26, 242, 484, 484+242 and 996 tone RUs. In addition, the 996 RU design for IM pilots could be repeated for any RU size greater than 996 tones. In such embodiments, each IM pilot design may use a different offset value for each of the RU sizes. For example, the IM pilot design for 242 sized RUs may have a first fixed delta or offset value (e.g., 5), and the IM pilot design for a 484 sized RU may have a second fixed delta or offset value (e.g., 4). As a result, a transmitter that will transmit a 242 sized RU may use the first interference mitigation pilot distribution grouping design (e.g., 21) will use the fixed delta or offset value corresponding to the 242-sized RU.

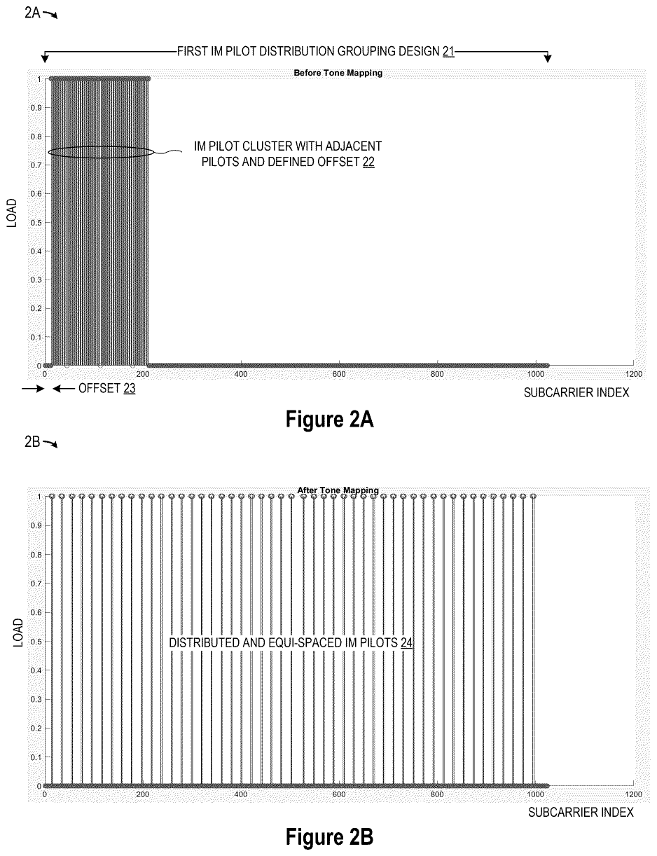

For an improved understanding of selected embodiments of the present disclosure, reference is now made to FIG. 2A which depicts a graphical plot 2A of a first interference mitigation pilot distribution grouping 21 having a single cluster 22 of adjacent IM pilots located at a specified delta or offset 23 for input to an LDPC tone mapper. As disclosed herein, the first interference mitigation pilot distribution grouping 21 may be generated by an IM pilot placement module component of a PHY PPDU generator. In the graphical plot 2A, the allocation pattern and density of the IM pilots for the first interference mitigation pilot distribution grouping 21 is plotted with the pilot load value on the y-axis (which shows a binary or unit value which indicates the presence of a pilot tone) and the subcarrier index value on the x-axis (which represents the frequency domain index). The depicted first interference mitigation pilot distribution grouping 21 appends the IM pilot cluster 21 at the beginning of the data tones for an example 80 MHz case with offset=0, though it will be appreciated that the IM pilot cluster 21 could instead be appended at the end of the data tones.

For an improved understanding of selected embodiments of the present disclosure, reference is now made to FIG. 2B which depicts a graphical plot 2B of a first distribution of interference mitigation pilots 24 that are spread across a specified bandwidth with a substantially uniformly spacing by an LDPC tone mapper in response to the first interference mitigation pilot distribution grouping 21 of FIG. 2A. As disclosed herein, the first distribution of interference mitigation pilots 24 may be generated by an LDPC tone mapper component of a PHY PPDU generator. In particular, the LDPC tone mapper processes the first interference mitigation pilot distribution grouping 21 so that the IM pilots in the first distribution of interference mitigation pilots 24 are equally spaced with uniform distribution across the bandwidth, though it will be appreciated that small deviations in the spacing distribution may occur.

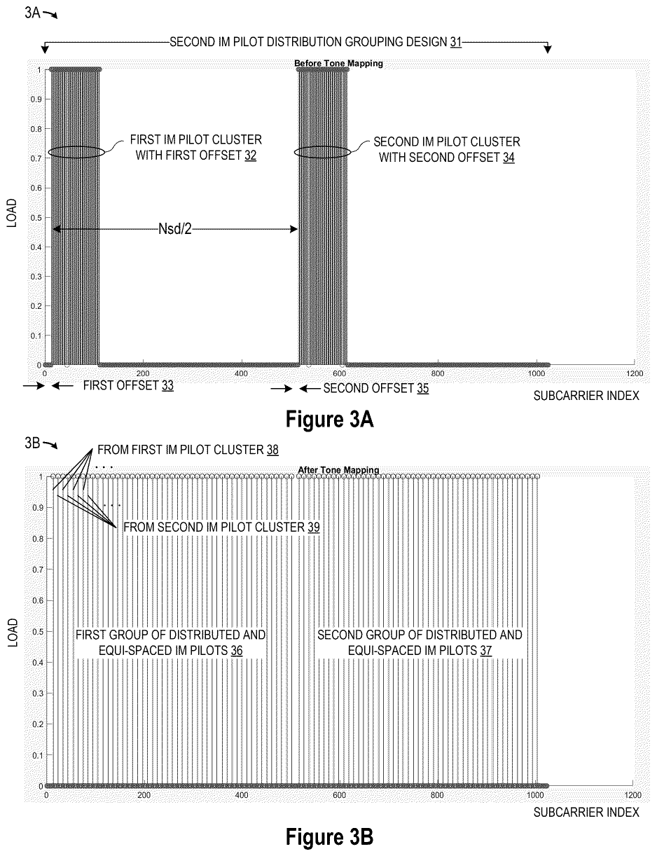

For an improved understanding of selected embodiments of the present disclosure, reference is now made to FIG. 3A which depicts a graphical plot 3A of a second interference mitigation pilot distribution grouping 31 having two clusters 32, 34, each having adjacent IM pilots located at a specified delta or offset 33, 35 for input to an LDPC tone mapper. As disclosed herein, second interference mitigation pilot distribution grouping 31 may be generated by an IM pilot placement module component of a PHY PPDU generator. In the graphical plot 3A, the allocation pattern and density of the IM pilots for the second interference mitigation pilot distribution grouping 31 is plotted to illustrate that IM pilots are divided into two clusters 32, 34 that are separated by a specified separation distance d=Nsd/2 as shown. For example, the first IM pilot cluster 32 could be appended at the beginning and the second IM pilot cluster 34 could be added at a distance of Nsd/2 from the beginning of the first IM pilot cluster 32. In this design, the data tones can be inserted between and after the first and second clusters 32, 34. With reference to an example 80 MHz case, the depicted second interference mitigation pilot distribution grouping 31 appends the first IM pilot cluster 32 with a first offset 33 (e.g., offset=0) and appends a second IM pilot cluster 34 with a second offset 35 (e.g., offset=0), where the beginning of each cluster 32, 34 is separated by a distance d=Nsd/2. As disclosed herein, each IM pilot cluster may have a different offset value or may use the same offset value.

For an improved understanding of selected embodiments of the present disclosure, reference is now made to FIG. 3B which depicts a graphical plot 3B of a second distribution of interference mitigation pilots 36, 37 which includes a first group of distributed and equi-spaced IM pilots 36 and a second group of distributed and equi-spaced IM pilots 37 which are spread across a specified bandwidth with a substantially uniformly spacing by an LDPC tone mapper in response to the second interference mitigation pilot distribution grouping 31. In particular, the first group of distributed and equi-spaced IM pilots 36 may be spread across a specified bandwidth with a substantially uniformly spacing by an LDPC tone mapper in response to the first IM pilot cluster 32 with the first offset value 33, and the second group of distributed and equi-spaced IM pilots 37 may be spread across a specified bandwidth with a substantially uniformly spacing by an LDPC tone mapper in response to the second IM pilot cluster 34 with the second offset value 35. In other embodiments, the alternating IM pilots in the second distribution of interference mitigation pilots 36, 37 may be spread across a specified bandwidth with a substantially uniformly spacing by an LDPC tone mapper by alternating the IM pilots from the first IM pilot cluster 38 with the IM pilots from the second IM pilot cluster 39, as shown. As disclosed herein, the second distribution of interference mitigation pilots 36, 37 may be generated by an LDPC tone mapper component of a PHY PPDU generator. In particular, the LDPC tone mapper processes the second interference mitigation pilot distribution grouping 31 so that the IM pilots in the first and second distribution of interference mitigation pilots 36, 37 are equally spaced with uniform distribution across the bandwidth, though it will be appreciated that small deviations in the spacing distribution may occur.

Though not illustrated in the Figures, it will be appreciated that an interference mitigation pilot distribution grouping may be designed to include three clusters, each having adjacent IM pilots located at a specified delta or offset (not shown) for input to an LDPC tone. IM Pilots can be divided in three clusters. With reference to an example 80 MHz case, the first IM pilot cluster could be appended at the beginning with a first offset value, the second IM pilot cluster could be added at a distance of Nsd/3 from the first IM pilot cluster 42, and the third IM pilot cluster could be added at a distance of Nsd/4 from the second IM pilot cluster.

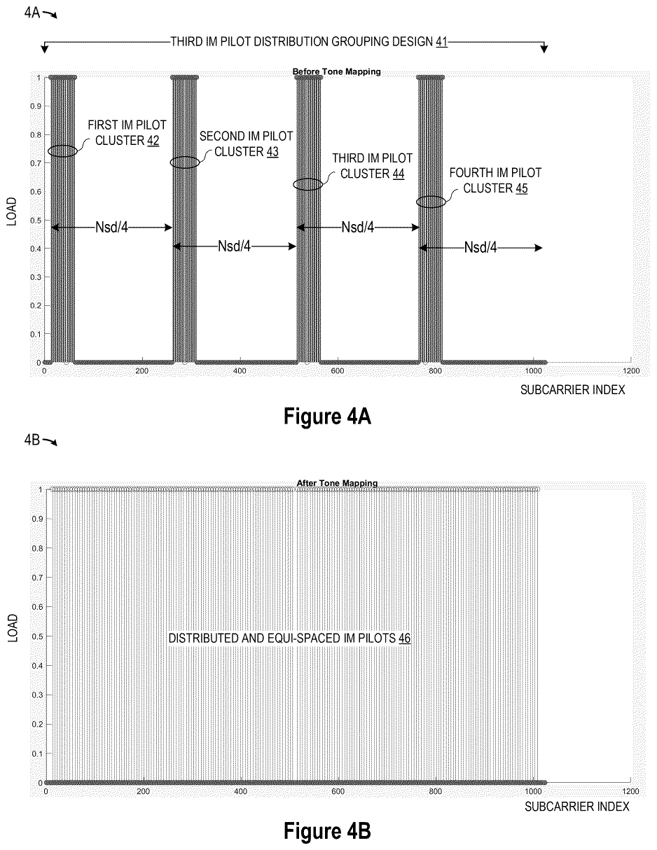

For an improved understanding of selected embodiments of the present disclosure, reference is now made to FIG. 4A which depicts a graphical plot 4A of a third interference mitigation pilot distribution grouping 41 having four clusters 42-45, each having adjacent IM pilots located at a specified delta or offset (not shown) for input to an LDPC tone mapper. As disclosed herein, third interference mitigation pilot distribution grouping 41 may be generated by an IM pilot placement module component of a PHY PPDU generator. In the graphical plot 4A, the allocation pattern and density of the IM pilots for the third interference mitigation pilot distribution grouping 41 is plotted to illustrate that IM pilots are divided into four clusters 42-45 that are separated from one another by specified separation distance d=Nsd/4 as shown. With reference to an example 80 MHz case, the depicted third interference mitigation pilot distribution grouping 41, the first IM pilot cluster 42 could be appended at the beginning with a first offset value, the second IM pilot cluster 43 could be added at a distance of Nsd/4 from the beginning of the first IM pilot cluster 42, the third IM pilot cluster 44 could be added at a distance of Nsd/4 from the beginning of the second IM pilot cluster 43, and the fourth IM pilot cluster 45 could be added at a distance of Nsd/4 from the beginning of the third IM pilot cluster 44. In this design, the data tones can be inserted between and after the clusters 42-45. As disclosed herein, each IM pilot cluster 42-45 may have a different offset value or may use the same offset value.

For an improved understanding of selected embodiments of the present disclosure, reference is now made to FIG. 4B which depicts a graphical plot 4B of a third distribution of interference mitigation pilots 46 which are spread across a specified bandwidth with a substantially uniformly spacing by an LDPC tone mapper in response to the third interference mitigation pilot distribution grouping 41 and which includes constituent groups of distributed and equi-spaced IM pilots generated, respectively, from the IM pilot clusters 42-45. As disclosed, the third distribution of interference mitigation pilots 46 operates on a full 80 MHz, i.e., which has number of loaded subcarriers=996. In particular, the third distribution of interference mitigation pilots 46 is spread across a specified bandwidth with a substantially uniformly spacing by an LDPC tone mapper in response to the third interference mitigation pilot distribution grouping 41. As disclosed herein, the third distribution of interference mitigation pilots 46 may be generated by an LDPC tone mapper component of a PHY PPDU generator. In particular, the LDPC tone mapper processes the third interference mitigation pilot distribution grouping 41 so that the IM pilots in the third distribution of interference mitigation pilots 46 are equally spaced with uniform distribution across the bandwidth, though it will be appreciated that small deviations in the spacing distribution may occur.

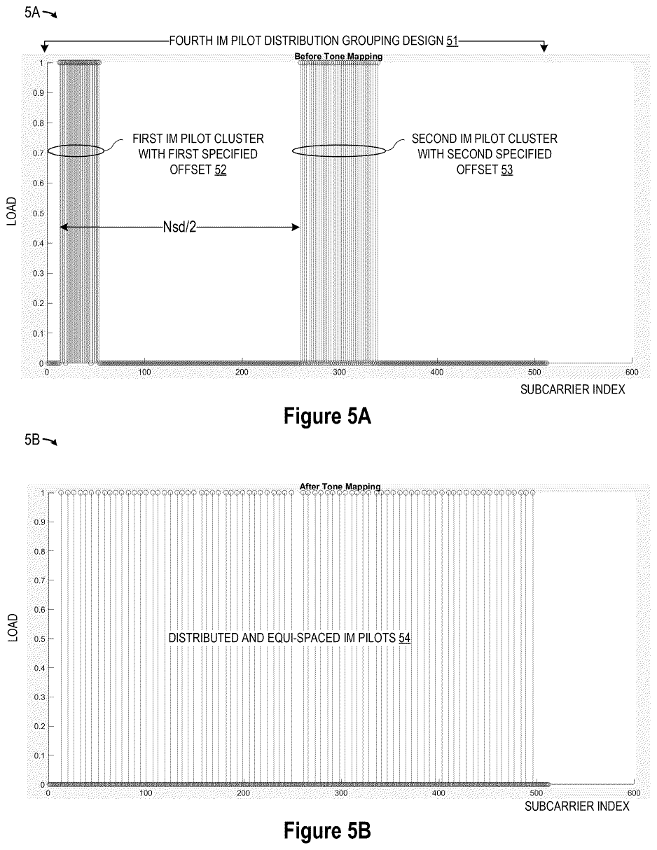

For an improved understanding of selected embodiments of the present disclosure, reference is now made to FIG. 5A which depicts a graphical plot 5A of a fourth interference mitigation pilot distribution grouping 51 which includes a first IM pilot cluster 52 with adjacent IM pilot subcarriers and a second IM pilot cluster 53 with alternating IM pilot and data subcarriers, where each IM pilots cluster 52, 53 located at a specified delta or offset (not shown) for input to an LDPC tone mapper. As disclosed herein, fourth interference mitigation pilot distribution grouping 51 may be generated by an IM pilot placement module component of a PHY PPDU generator. In the graphical plot 5A, the allocation pattern and density of the IM pilots for the fourth interference mitigation pilot distribution grouping 51 is plotted to illustrate that IM pilots are divided into two clusters 52, 53 that are separated from one another by specified separation distance d=Nsd/2 as shown. With reference to an example 40 MHz case, the fourth interference mitigation pilot distribution grouping 51 may include the first IM pilot cluster 52 that appended at the beginning with a first offset value, and a second IM pilot cluster 53 added at a distance of Nsd/2 from beginning of the first IM pilot cluster 52. In this design, the data tones can be inserted between and after the clusters 52-53. As disclosed herein, each IM pilot cluster 52-53 may have a different offset value or may use the same offset value.

For an improved understanding of selected embodiments of the present disclosure, reference is now made to FIG. 5B which depicts a graphical plot 5B of a fourth distribution of interference mitigation pilots 54 which includes constituent groups of distributed and equi-spaced IM pilots generated, respectively, from the IM pilot clusters 52, 53. As disclosed, the fourth distribution of interference mitigation pilots 54 is spread across a specified bandwidth with a substantially uniformly spacing by an LDPC tone mapper in response to the fourth interference mitigation pilot distribution grouping 51. As disclosed herein, the fourth distribution of interference mitigation pilots 54 may be generated by an LDPC tone mapper component of a PHY PPDU generator. In particular, the LDPC tone mapper processes the fourth interference mitigation pilot distribution grouping 51 so that the IM pilots in the fourth distribution of interference mitigation pilots 54 are equally spaced with uniform distribution across the bandwidth, though it will be appreciated that small deviations in the spacing distribution may occur.

### Interference Mitigation Pilot Designs for 80 MHz PPDU

Apart from the IM pilot designs defined above, IM pilot designs for an example 80 MHz case can also be defined to use the 484+484 RU for the 80 MHz loading. Rather than define an IM pilot plan for the entire 80 MHz channel, a first IM pilot plan for a 484 RU is used to place the IM pilot cluster(s) for input to the LDPC tone mapper. Referring back to FIG. 4A, the first and second IM pilot clusters 42, 43 within the first 484 RU can be used to define the IM pilot tone plan that is input to the LDPC tone mapper. In a first example design, 234 tones can be used as IM pilots, and the remaining 702 tones in 484+484 RU case can be used for data. In this case, the number of data tones will be equivalent to 484+242 RU. In a second example design, the IM pilot design for 484 tones can be repeated for 80 MHz in 484+484 RU case.

### Downlink or Uplink OFDMA

As disclosed herein, combinations of the interference mitigation pilot distribution grouping designs 21, 31, 41, 51 can be used for downlink OFDMA cases. For example, in a 3-user case for transmitting 484+242+242 RUs, the IM pilot design for each user will be designed within the specified RU. In an example 80 MHz case where the first user has a 484 RU, the second user has a 242 RU, and the third user has a 242 RU, then the IM pilot design will be used independently for each user. Referring back to FIG. 4A, the first and second IM pilot clusters 42, 43 within the first 484 RU can be used to define the IM pilot tone plan for the first user, the third IM pilot cluster 44 within the first 242 RU can be used to define the IM pilot tone plan for the second user, and the fourth IM pilot cluster 45 within the second 242 RU can be used to define the IM pilot tone plan for the third user. As a result, the first user will adopt the 484 RU sized pilots, the second user will adopt the 242 RU sized pilots at its location, and the third user will adopt the 242 RU sized pilots at its location. With the disclosed IM pilot designs, there is no mixing across users. Each RU can have any design which is chosen based on the RU size.

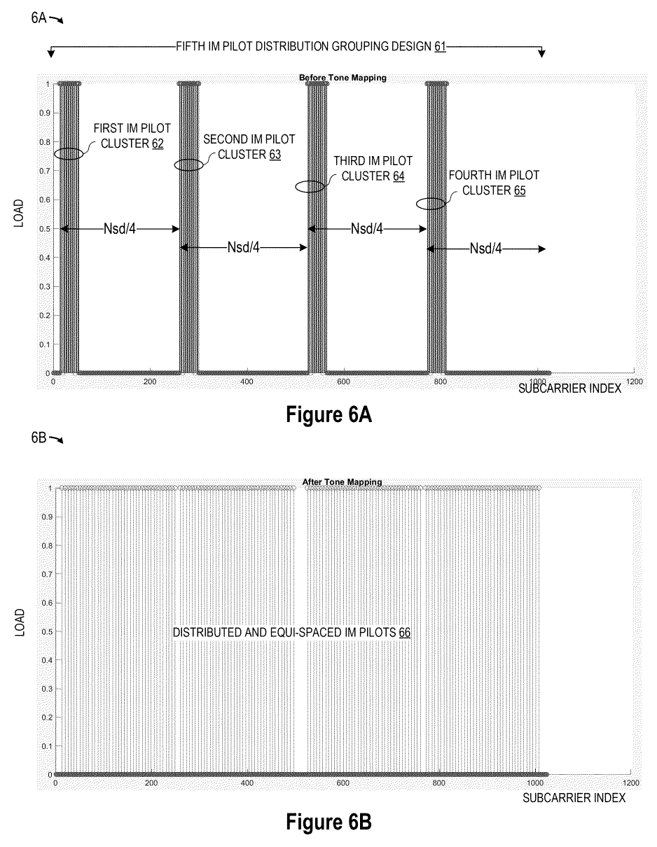

For an improved understanding of selected embodiments of the present disclosure, reference is now made to FIG. 6A which depicts a graphical plot 6A of a fifth interference mitigation pilot distribution grouping 61 having four IM pilot clusters 62-65 for input to an LDPC tone mapper, each cluster having adjacent IM pilots located at a specified delta or offset (not shown) for input. As disclosed herein, fifth interference mitigation pilot distribution grouping 61 may be generated by an IM pilot placement module component of a PHY PPDU generator. In the graphical plot 6A, the allocation pattern and density of the IM pilots for the fifth interference mitigation pilot distribution grouping 61 is plotted to illustrate that IM pilots are divided into four clusters 62-65 that are separated from one another by specified separation distance d=Nsd/4 as shown. With reference to an example 80 MHz case, the depicted fifth interference mitigation pilot distribution grouping 61, the first IM pilot cluster 62 could be appended at the beginning with a first offset value, the second IM pilot cluster 63 could be added at a distance of Nsd/4 from the beginning of the first IM pilot cluster 62, the third IM pilot cluster 64 could be added at a distance of Nsd/4 from the beginning of the second IM pilot cluster 63, and the fourth IM pilot cluster 65 could be added at a distance of Nsd/4 from the beginning of the third IM pilot cluster 64. In this design, the data tones can be inserted between and after the clusters 62-65. As disclosed herein, each IM pilot cluster 62-65 may have a different offset value or may use the same offset value.

For an improved understanding of selected embodiments of the present disclosure, reference is now made to FIG. 6B which depicts a graphical plot 6B of a fifth distribution of interference mitigation pilots 66 which are spread across a specified bandwidth with a substantially uniformly spacing by an LDPC tone mapper in response to the fifth interference mitigation pilot distribution grouping 61 and which includes constituent groups of distributed and equi-spaced IM pilots generated, respectively, from the IM pilot clusters 62-65. As disclosed, the fifth distribution of interference mitigation pilots 66 operates on a two RU format within 80 MHz (484+484), i.e., the number of loaded subcarriers=2*484. As seen in the fifth distribution of interference mitigation pilots 66, the location of the regular pilots will be slightly different from the example shown in FIG. 4B. As disclosed herein, the fifth distribution of interference mitigation pilots 66 may be generated by an LDPC tone mapper component of a PHY PPDU generator. In particular, the LDPC tone mapper processes the fifth interference mitigation pilot distribution grouping 61 so that the IM pilots in the third distribution of interference mitigation pilots 66 are equally spaced with uniform distribution across the bandwidth, though it will be appreciated that small deviations in the spacing distribution may occur.

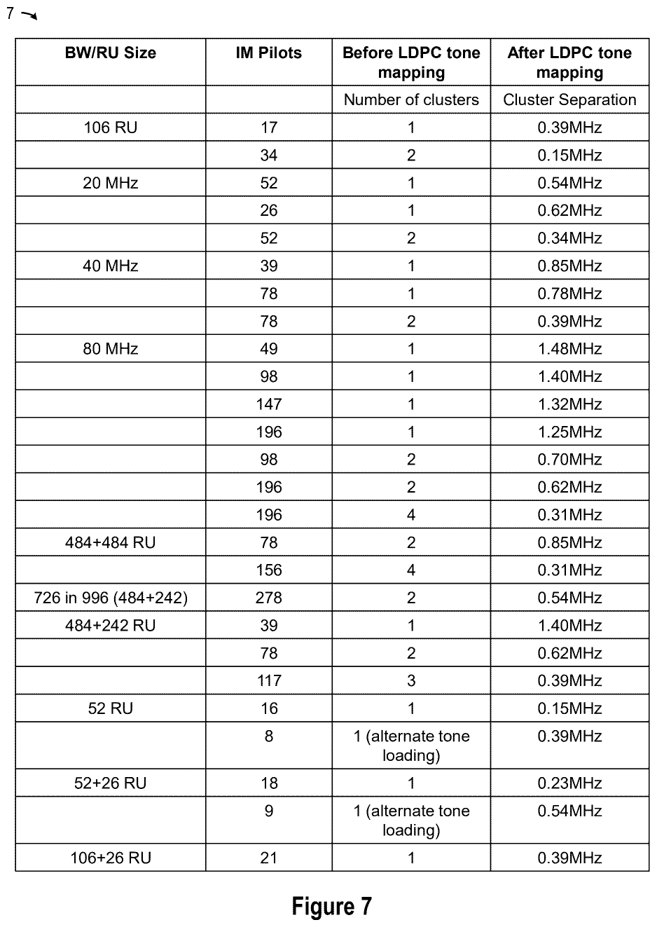

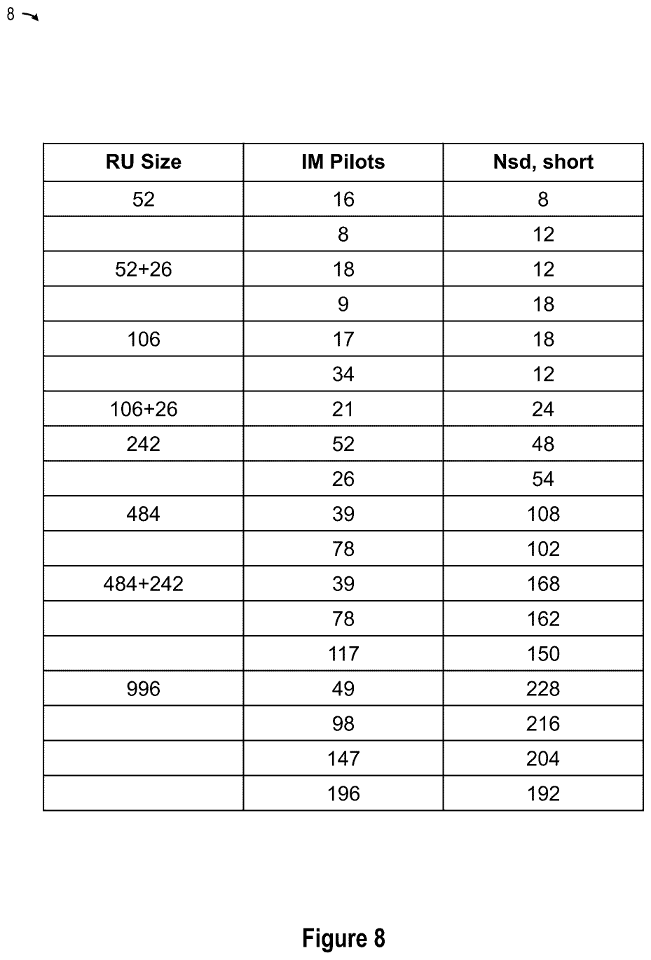

For an improved understanding of selected embodiments of the present disclosure, reference is now made to FIG. 7 which depicts a table 7 of IM pilot design parameters for different bandwidth and RU sizes. As depicted in the table 7, the IM pilot design for a 106 RU may include 17 IM pilots arranged in a single IM pilot cluster which is processed by an LDPC tone mapper to generate a plurality of output IM pilots that are substantially uniformly spread over the 80 MHz PPDU with a separation of 0.39 MHz between two IM pilots at the LDPC tone mapper output. An alternative IM pilot design for the 106 RU may include 34 IM pilots arranged in two IM pilot clusters which are processed by an LDPC tone mapper to generate a plurality of output IM pilots that are substantially uniformly spread over the 80 MHz PPDU with a cluster separation of 0.15 MHz.

In addition, the IM pilot design for a 20 MHz bandwidth may include 52 IM pilots arranged in a single IM pilot cluster which is processed by an LDPC tone mapper to generate a plurality of output IM pilots that are substantially uniformly spread over the 80 MHz PPDU with a separation of 0.54 MHz between two IM pilots at the LDPC tone mapper output. An alternative IM pilot design for the 20 MHz bandwidth may include 26 IM pilots arranged in a single IM pilot cluster which is processed by an LDPC tone mapper to generate a plurality of output IM pilots that are substantially uniformly spread over the 80 MHz PPDU with a cluster separation of 0.62 MHz. Another alternative IM pilot design for the 20 MHz bandwidth may include 52 IM pilots arranged in two IM pilot clusters which are processed by an LDPC tone mapper to generate a plurality of output IM pilots that are substantially uniformly spread over the 80 MHz PPDU with a cluster separation of 0.34 MHz.

In addition, the IM pilot design for a 40 MHz bandwidth may include 39 IM pilots arranged in a single IM pilot cluster which is processed by an LDPC tone mapper to generate a plurality of output IM pilots that are substantially uniformly spread over the 80 MHz PPDU with a separation of 0.85 MHz between two IM pilots at the LDPC tone mapper output. An alternative IM pilot design for the 40 MHz bandwidth may include 78 IM pilots arranged in a single IM pilot cluster which is processed by an LDPC tone mapper to generate a plurality of output IM pilots that are substantially uniformly spread over the 80 MHz PPDU with a cluster separation of 0.78 MHz. Another alternative IM pilot design for the 40 MHz bandwidth may include 78 IM pilots arranged in two IM pilot clusters which are processed by an LDPC tone mapper to generate a plurality of output IM pilots that are substantially uniformly spread over the 80 MHz PPDU with a cluster separation of 0.39 MHz.

In addition, the IM pilot design for an 80 MHz bandwidth may include 49 IM pilots arranged in a single IM pilot cluster which is processed by an LDPC tone mapper to generate a plurality of output IM pilots that are substantially uniformly spread over the 80 MHz PPDU with a separation of 1.48 MHz between two IM pilots at the LDPC tone mapper output. An alternative IM pilot design for the 80 MHz bandwidth may include 98 IM pilots arranged in a single IM pilot cluster which is processed by an LDPC tone mapper to generate a plurality of output IM pilots that are substantially uniformly spread over the 80 MHz PPDU with a cluster separation of 1.4 MHz. An alternative IM pilot design for the 80 MHz bandwidth may include 147 IM pilots arranged in a single IM pilot cluster which is processed by an LDPC tone mapper to generate a plurality of output IM pilots that are substantially uniformly spread over the 80 MHz PPDU with a cluster separation of 1.32 MHz. An alternative IM pilot design for the 80 MHz bandwidth may include 196 IM pilots arranged in a single IM pilot cluster which is processed by an LDPC tone mapper to generate a plurality of output IM pilots that are substantially uniformly spread over the 80 MHz PPDU with a cluster separation of 1.25 MHz. Another alternative IM pilot design for the 80 MHz bandwidth may include 98 IM pilots arranged in two IM pilot clusters which are processed by an LDPC tone mapper to generate a plurality of output IM pilots that are substantially uniformly spread over the 80 MHz PPDU with a cluster separation of 0.7 MHz. Another alternative IM pilot design for the 80 MHz bandwidth may include 196 IM pilots arranged in two IM pilot clusters which are processed by an LDPC tone mapper to generate a plurality of output IM pilots that are substantially uniformly spread over the 80 MHz PPDU with a cluster separation of 0.62 MHz. Another alternative IM pilot design for the 80 MHz bandwidth may include 196 IM pilots arranged in four IM pilot clusters which are processed by an LDPC tone mapper to generate a plurality of output IM pilots that are substantially uniformly spread over the 80 MHz PPDU with a cluster separation of 0.31 MHz.

In addition, the IM pilot design for a 484+484 RU may include 78 IM pilots arranged in two IM pilot clusters which are processed by an LDPC tone mapper to generate a plurality of output IM pilots that are substantially uniformly spread over the 80 MHz PPDU with a separation of 0.85 MHz between two IM pilots at the LDPC tone mapper output. An alternative IM pilot design for the 484+484 RU may include 156 IM pilots arranged in four IM pilot clusters which are processed by an LDPC tone mapper to generate a plurality of output IM pilots that are substantially uniformly spread over the 80 MHz PPDU with a cluster separation of 0.31 MHz.

In addition, the IM pilot design for a 726 in 996 RU (484+242 RU) may include 278 IM pilots arranged in 2 IM pilot clusters which are processed by an LDPC tone mapper to generate a plurality of output IM pilots that are substantially uniformly spread over the 80 MHz PPDU with a separation of 0.54 MHz between two IM pilots at the LDPC tone mapper output.

In addition, the IM pilot design for a 484+242 RU may include 39 IM pilots arranged in a single IM pilot cluster which is processed by an LDPC tone mapper to generate a plurality of output IM pilots that are substantially uniformly spread over the 80 MHz PPDU with a separation of 1.4 MHz between two IM pilots at the LDPC tone mapper output. An alternative IM pilot design for the 484+242 RU may include 78 IM pilots arranged in two IM pilot clusters which are processed by an LDPC tone mapper to generate a plurality of output IM pilots that are substantially uniformly spread over the 80 MHz PPDU with a cluster separation of 0.62 MHz. An alternative IM pilot design for the 484+242 RU may include 117 IM pilots arranged in three IM pilot clusters which are processed by an LDPC tone mapper to generate a plurality of output IM pilots that are substantially uniformly spread over the 80 MHz PPDU with a cluster separation of 0.39 MHz.

In addition, the IM pilot design for a 52 RU may include 16 IM pilots arranged in a single IM pilot cluster which is processed by an LDPC tone mapper to generate a plurality of output IM pilots that are substantially uniformly spread over the 80 MHz PPDU with a separation of 0.15 MHz between two IM pilots at the LDPC tone mapper output. An alternative IM pilot design for the 52 RU may include 8 IM pilots arranged in a single alternate tone loading cluster which is processed by an LDPC tone mapper to generate a plurality of output IM pilots that are substantially uniformly spread over the 80 MHz PPDU with a cluster separation of 0.39 MHz.

In addition, the IM pilot design for a 52+26 RU may include 18 IM pilots arranged in a single IM pilot cluster which is processed by an LDPC tone mapper to generate a plurality of output IM pilots that are substantially uniformly spread over the 80 MHz PPDU with a separation of 0.23 MHz between two IM pilots at the LDPC tone mapper output. An alternative IM pilot design for the 52+26 RU may include 9 IM pilots arranged in a single alternate tone loading cluster which is processed by an LDPC tone mapper to generate a plurality of output IM pilots that are substantially uniformly spread over the 80 MHz PPDU with a cluster separation of 0.54 MHz.

In addition, the IM pilot design for a 106+26 RU may include 21 IM pilots arranged in a single IM pilot cluster which is processed by an LDPC tone mapper to generate a plurality of output IM pilots that are substantially uniformly spread over the 80 MHz PPDU with a separation of 0.30 MHz between two IM pilots at the LDPC tone mapper output.

As will be appreciated, Nsd, short is conventionally used to represent the number of data subcarriers in the last symbol, i.e., when “pre-FEC padding factor” is set to {i, i=1, 2, 3}, then the number of data subcarriers in last symbol is “pre-FEC padding factor” *i, else the number of data subcarriers in last symbol is Nsd. Typically, the actual value of is determined by the Resource Unit (RU) size and whether the transmission uses Dual Carrier Modulation (DCM), and represents the number of data-carrying subcarriers available within a single Orthogonal Frequency-Division Multiplexing (OFDM) symbol for a specific Resource Unit configuration. However, to account for the different IM pilot design disclosed herein, the Nsd, short for different RU and MRUs should be adjusted to provide a new Nsd, short that is computed approximately as Nsd, short−Nim/4, where Nim is number of IM pilots.

For an improved understanding of selected embodiments of the present disclosure, reference is now made to FIG. 7 which depicts a table 8 of adjusted Nsd, short values for different RU and MRU sizes. As depicted in the table 8, the IM pilot design for a 52 RU having 16 IM pilots will have an adjusted Nsd, short =8. An alternative IM pilot design for the 52 RU having 8 IM pilots will have an adjusted Nsd, short=12.

In addition, the IM pilot design for a 52+26 RU having 18 IM pilots will have an adjusted Nsd, short=12. An alternative IM pilot design for the 52+26 RU having 9 IM pilots will have an adjusted Nsd, short=18.

In addition, the IM pilot design for a 106 RU having 17 IM pilots will have an adjusted Nsd, short=18. An alternative IM pilot design for the 106 RU having 34 IM pilots will have an adjusted Nsd, short=12.

In addition, the IM pilot design for a 106+26 RU having 21 IM pilots will have an adjusted Nsd, short=24.

In addition, the IM pilot design for a 242 RU having 52 IM pilots will have an adjusted Nsd, short =48. An alternative IM pilot design for the 242 RU having 26 IM pilots will have an adjusted Nsd, short=54.

In addition, the IM pilot design for a 484 RU having 39 IM pilots will have an adjusted Nsd, short=108. An alternative IM pilot design for the 484 RU having 78 IM pilots will have an adjusted Nsd, short=102.

In addition, the IM pilot design for a 484+242 RU having 39 IM pilots will have an adjusted Nsd, short=168. An alternative IM pilot design for the 484+242 RU having 78 IM pilots will have an adjusted Nsd, short=162. Another alternative IM pilot design for the 484+242 RU having 117 IM pilots will have an adjusted Nsd, short=150.

In addition, the IM pilot design for a 996 RU having 49 IM pilots will have an adjusted Nsd, short=228. An alternative IM pilot design for the 996 RU having 98 IM pilots will have an adjusted Nsd, short=216. Another alternative IM pilot design for the 996 RU having 147 IM pilots will have an adjusted Nsd, short=204. Another alternative IM pilot design for the 996 RU having 196 IM pilots will have an adjusted Nsd, short=192.

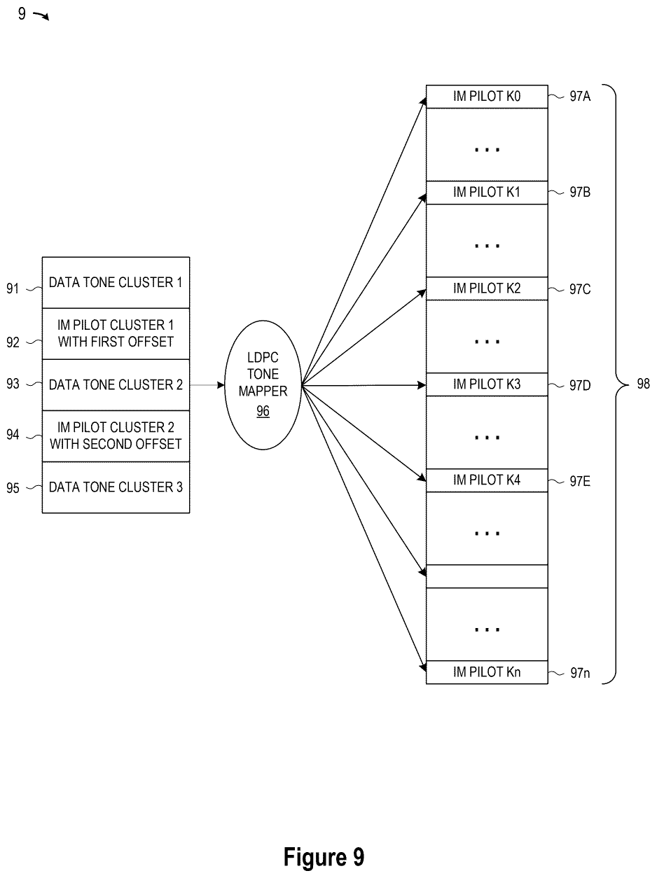

For an improved understanding of selected embodiments of the present disclosure, reference is now made to FIG. 9 which illustrates an IM pilot encoding system 9 wherein a LDPC tone mapper 96 encodes or maps an input set of one or more IM pilot clusters 91-95 into a disjoint set of pilot subcarriers 97A-n that are substantially uniformly distributed across a specified bandwidth 98 for transmission in a PPDU. As depicted, the one or more IM pilot clusters 91-95 may be designed to include a first data tone cluster 91, a first IM pilot cluster 92 that is positioned with a first offset, a second data tone cluster 93, a second IM pilot cluster 94 that is positioned with a second offset, and a third data tone cluster 95 which are sequentially appended in a sequence. As will be appreciated, the input set of IM pilot clusters may include additional or fewer IM pilot clusters, and each IM pilot cluster may have a shared or separate offset value.

In accordance with the present disclosure, the input set of one or more IM pilot clusters 91-95 may be encoded and modulated using an encoding bandwidth or logical resource unit(s) (RUs) for input to the LDPC tone mapper 96 which is programmed and configured to distribute the individual IM pilots from the IM pilot cluster(s) onto a disjoint set of subcarriers 97A-n across a second (wider) signal bandwidth 98. As will be appreciated, the role of the LDPC tone mapper 96 in this context is to distribute adjacent input values into disjoint subcarriers in order to avoid any burst error. To this end, the LDPC tone mapper 96 performs physical layer resource assignment, where it determines which subcarrier indices are assigned to which function (data, pilot, guard, DC) based on one or more input parameters, such as RU allocation parameters, pilot spacing/density parameters, Nim parameters specifying the total number of interference mitigation pilot subcarriers to be inserted for the given RU.

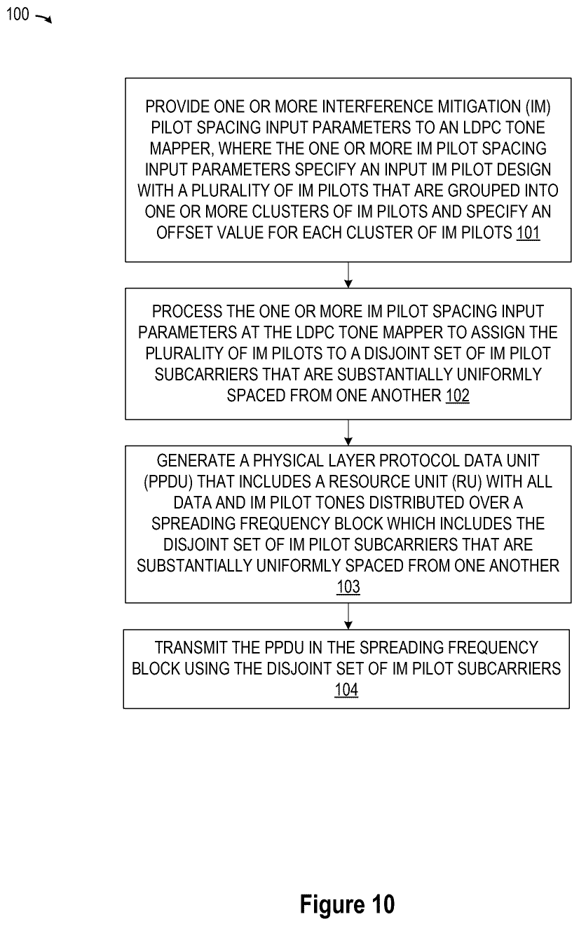

Turning now to FIG. 10, there is depicted a flow diagram 10 of a technique for wireless communications in accordance with selected embodiments of the present disclosure. At step 101, one or more interference mitigation (IM) pilot spacing input parameters are provided to an LDPC tone mapper, where the one or more IM pilot spacing input parameters specify an input IM pilot design with a plurality of IM pilots that are grouped into one or more clusters of IM pilots and specify an offset value for each cluster of IM pilots. At step 102, the LDPC tone mapper processes the one or more IM pilot spacing input parameters to assign the plurality of IM pilots to a disjoint set of IM pilot subcarriers that are substantially uniformly spaced from one another. At step 103, a PPDU may be generated that includes an RU that includes a resource unit (RU) with all data and IM pilot tones distributed over a spreading frequency block which includes the disjoint set of IM pilot subcarriers that are substantially uniformly spaced from one another. At block 104, the PPDU may be transmitted in the spreading frequency block using the disjoint set of IM pilot subcarriers.

In accordance with the present disclosure, there is provided a plurality of different input interference mitigation (IM) pilot designs for processing by an LDPC tone mapper. In selected embodiments, an input IM pilot design includes a one or more IM pilot clusters with each cluster having a “delta” offset. In such embodiments, the input IM pilot design appends all IM pilots as one IM pilot cluster at the beginning or the end of data tones. In other such embodiments, the input IM pilot design divides the IM pilots into two clusters with a first separation distance d separating the two clusters. In other such embodiments, the input IM pilot design divides the IM pilots into three clusters with a first separation distance d1 separating the first and second clusters, and with a second separation distance d2 separating the second and third clusters. In other such embodiments, the input IM pilot design divides the IM pilots into four clusters with a first separation distance d1 separating the first and second clusters, with a second separation distance d2 separating the second and third clusters, with a third separation distance d3 separating the third and fourth second clusters. In other such embodiments, the IM pilots can be alternately loaded with data tones for one or more of the clusters.

In embodiments where all IM pilots are appended as one IM pilot cluster at the beginning or the end of data tones, the input IM pilot design may use 17 IM pilots for 106 RU, or may use 52 or 26 IM pilots for 20 MHz (242 RU), or may use 39 or 78 IM pilots for 40 MHz (484 RU), or may use 49 or 98 or 147 or 196 IM pilots for 80 MHz (996 RU), or may use 16 IM pilots for 52 RU, or may use 18 IM pilots for 52+26 RU, or may use 21 IM pilots for 106+26RU, or may use 39 IM pilots for 484+242 RU. In embodiments where all IM pilots are divided into two IM pilot clusters with a first separation distance d separating the two clusters, the input IM pilot design may use 34 IM pilots for 106 RU, or may use 52 IM pilots for 20 MHz (242 RU), or may use 78 IM pilots for 40 MHz (484 RU), or may use 196 IM pilots for 80 MHz (996 RU), or may use 78 IM pilots for 484+242 RU, or may use 278 IM pilots for 484+484 RU. In embodiments where all IM pilots are divided into three clusters with respective separation distances d1, d2, the input IM pilot design may use 117 IM pilots for 484+242 RU. In embodiments where all IM pilots are divided into four clusters with respective separation distances d1, d2, d3, the input IM pilot design may use 196 IM pilots for 80 MHz (996 RU) or may use 156 IM pilots for 484+484 RU. In embodiments where the IM pilots can be alternately loaded with data tones for one or more of the clusters, the input IM pilot design may alternately load 8 IM pilots for 52 RU or may alternately load 9 IM pilots for 52+26 RU. In selected embodiments, combinations of designs for each individual user according to specified RU/MRUs can be used for downlink or uplink OFDMA cases.

In selected embodiments, the input IM pilot design may use an updated Nsd_short value Nsd_short_update=Nsd_short-Nim/4. In such embodiments, the Nsd_short_update value may use 8 tones or 12 tones for IM pilots designs where the number of IM pilots is 16 tones and 8 tones, respectively, for 52 RU. In other such embodiments, the Nsd_short_update value may use 12 tones and 18 tones for IM pilots designs where the number of IM pilots is 18 tones and 9 tones, respectively, for 52+26 RU. In other such embodiments, the Nsd_short_update value may use 18 tones and 12 tones for IM pilots designs where the number of IM pilots is 17 tones and 34 tones, respectively, for 106 RU. In other such embodiments, the Nsd_short_update value may use 24 tones for IM pilots designs where the number of IM pilots is 21 tones for 106+26 RU. In other such embodiments, the Nsd_short_update value may use 48 and 54 tones for IM pilots designs where the number of IM pilots is 52 tones and 26 tones, respectively, for 242 RU. In other such embodiments, the Nsd_short_update value may use 102 and 108 tones for IM pilots designs where the number of IM pilots is 78 tones and 39 tones, respectively, for 484 RU. In other such embodiments, the Nsd_short_update value may use 168, 162 and 150 tones for IM pilots designs where the number of IM pilots is 39, 78 and 117 tones, respectively, for 484+242 RU. In other such embodiments, the Nsd_short_update value may use 228, 216, 204 and 192 tones for IM pilots designs where the number of IM pilots is 49, 98, 147 and 196 tones, respectively, for 996 RU.

By now it should be appreciated that there has been provided an apparatus, method, and system for generating IM pilot subcarriers by a first wireless device in accordance with IEEE 802.11 protocol. In the disclosed method, a first wireless device provides one or more interference mitigation (IM) pilot spacing input parameters to a Low-Density Parity-Check (LDPC) tone mapper, where the one or more IM pilot spacing input parameters specify an input IM pilot design with a plurality of IM pilots that are grouped into one or more clusters of IM pilots and specify an offset value for each cluster of IM pilots. In selected embodiments, each cluster of IM pilots has a different offset value. In other selected embodiments, the one or more IM pilot spacing input parameters specify that the input IM pilot design includes a single IM pilot cluster which contains the plurality of IM pilots. In such embodiments, the one or more IM pilot spacing input parameters may specify that the input IM pilot design may use 17 IM pilots for 106 RU, or may use 52 or 26 IM pilots for 20 MHz (242 RU), or may use 39 or 78 IM pilots for 40 MHz (484 RU), or may use 49 or 98 or 147 or 196 IM pilots for 80 MHz (996 RU), or may use 16 IM pilots for 52 RU, or may use 18 IM pilots for 52+26 RU, or may use 21 IM pilots for 106+26 RU, or may use 39 IM pilots for 484+242 RU. In other selected embodiments, the one or more IM pilot spacing input parameters specify that the input IM pilot design includes a first IM pilot cluster and a second IM pilot cluster which is separated from the first IM pilot cluster by a first separation distance Nsd/2. In such embodiments, the one or more IM pilot spacing input parameters may specify that the input IM pilot design may use 34 IM pilots for 106 RU, or may use 52 IM pilots for 20 MHz (242 RU), or may use 78 IM pilots for 40 MHz (484 RU), or may use 196 IM pilots for 80 MHz (996 RU), or may use 78 IM pilots for 484+242 RU, or may use 278 IM pilots for 484+484 RU. In other selected embodiments, the one or more IM pilot spacing input parameters specify the input IM pilot design includes a first IM pilot cluster, a second IM pilot cluster, and a third IM pilot cluster, where the first IM pilot cluster and second IM pilot cluster are separated by a separation distance Nsd/3, and where the second IM pilot cluster and third IM pilot cluster are separated by the separation distance Nsd/3. In such embodiments, the one or more IM pilot spacing input parameters may specify that the input IM pilot design may use 117 IM pilots for 484+242 RU. In other selected embodiments, the one or more IM pilot spacing input parameters specify the input IM pilot design includes a first IM pilot cluster, a second IM pilot cluster, a third IM pilot cluster, and a fourth IM pilot cluster, where the first and second IM pilot clusters are separated by a separation distance Nsd/4, where the second and third IM pilot clusters are separated by the separation distance Nsd/4, and where the third and fourth IM pilot clusters are separated by the separation distance Nsd/4. In such embodiments, the one or more IM pilot spacing input parameters may specify that the input IM pilot design may use 196 IM pilots for 80 MHz (996 RU) or may use 156 IM pilots for 484+484 RU. In other selected embodiments, the one or more IM pilot spacing input parameters specify the input IM pilot design includes at least one of the one or more clusters of IM pilots is alternately loaded with data tones. In such embodiments, the one or more IM pilot spacing input parameters may specify that the input IM pilot design may include at least one of the one or more clusters of IM pilots that is alternately loaded with 8 IM pilots for 52 RU or is alternately loaded with 9 IM pilots for 52+26 RU. In addition, the disclosed method generates a Physical Layer Protocol Data Unit (PPDU) that includes a resource unit (RU) or multi-RU (MRU), wherein the LDPC tone mapper processes the one or more IM pilot spacing parameters to identify a disjoint set of IM pilot subcarriers that are substantially uniformly space within the RU or MRU. In selected embodiments, the PPDU may be generated by defining an updated number of data subcarriers parameter (Nsd, short_updated) as Nsd, short−Nim/4, where Nim specifies a count of the plurality of IM pilots, and where Nsd, short specifies a count of data subcarriers available for the transmission of data bits within the last OFDM symbol for a given “pre-FEC padding factor” value. In such embodiments, the updated number of data subcarriers parameter (Nsd_short_update) may specify that 8 tones or 12 data tones may be used for the IM pilot designs which have, respectively, 16 IM pilot tones and 8 IM pilot tones for 52 RU. In other such embodiments, the updated number of data subcarriers parameter (Nsd_short_update) may specify that 12 tones or 18 data tones may be used for the IM pilot designs which have, respectively, 17 IM pilot tones and 34 IM pilot tones for 52+26 RU. In other such embodiments, the updated number of data subcarriers parameter (Nsd_short_update) may specify that 18 tones or 12 data tones may be used for the IM pilot designs which have, respectively, 18 IM pilot tones and 9 IM pilot tones for 106 RU. In other such embodiments, the updated number of data subcarriers parameter (Nsd_short_update) may specify that 24 tones may be used for the IM pilot designs which have 21 IM pilot tones for 10+26 RU. In other such embodiments, the updated number of data subcarriers parameter (Nsd_short_update) may specify that 48 tones or 54 data tones may be used for the IM pilot designs which have, respectively, 52 IM pilot tones and 36 IM pilot tones for 242 RU. In other such embodiments, the updated number of data subcarriers parameter (Nsd_short_update) may specify that 102 tones or 108 data tones may be used for the IM pilot designs which have, respectively, 78 IM pilot tones and 39 IM pilot tones for 484 RU. In other such embodiments, the updated number of data subcarriers parameter (Nsd_short_update) may specify that 168, 162 and 150 data tones may be used for the IM pilot designs which have, respectively, 39, 78 and 117 pilot tones for 484+242 RU. In other such embodiments, the updated number of data subcarriers parameter (Nsd_short_update) may specify that 228, 216, 204 and 192 data tones may be used for the IM pilot designs which have, respectively, 49, 98, 147 and 196 pilot tones for 996 RU. The disclosed method also transmits the PPDU in the spreading frequency block by using the disjoint set of IM pilot subcarriers. In selected embodiments, the first wireless device transmits the PPDU using Orthogonal Frequency-Division Multiple Access (OFDMA). In selected embodiments of the disclosed method, the offset value is applied to the output subcarrier index of the LDPC tone mapper.

In another form, there is provided a first wireless device, system, and associated method of operation. As disclosed, the first wireless device includes a plurality of wireless transceivers, a memory including operational instructions, and one or more processing modules operably coupled to the plurality of wireless transceivers and the memory, where the one or more processing modules are configured to execute the operational instructions to generate IM pilot subcarriers in accordance with Institute of Electrical and Electronics Engineers (IEEE) 802.11 protocol. In particular, the one or more processing modules are configured to execute the operational instructions for providing one or more interference mitigation (IM) pilot spacing input parameters to a Low-Density Parity-Check (LDPC) tone mapper, where the one or more IM pilot spacing input parameters specify an input IM pilot design with a plurality of IM pilots that are grouped into one or more clusters of IM pilots and specify an offset value for each cluster of IM pilots. In addition, the one or more processing modules are configured to execute the operational instructions for processing the one or more IM pilot spacing input parameters at the LDPC tone mapper to assign the plurality of IM pilots to a disjoint set of IM pilot subcarriers that are substantially uniformly spaced from one another. In addition, the one or more processing modules are configured to execute the operational instructions for generating a Physical Layer Protocol Data Unit (PPDU) that includes a resource unit (RU) with all data and IM pilot tones distributed over a spreading frequency block which includes the disjoint set of IM pilot subcarriers that are substantially uniformly spaced from one another. In addition, the one or more processing modules are configured to execute the operational instructions for transmitting the PPDU in the spreading frequency block by using the disjoint set of IM pilot subcarriers. In selected embodiments, the input IM pilot design includes a single cluster of IM pilots with an output subcarrier index having a specified offset value, where the single cluster of IM pilots is appended at a beginning or an end of a plurality of data tones for input to the LDPC tone mapper. In other selected embodiments, the input IM pilot design includes two clusters of IM pilots, each having an output subcarrier index having a specified offset value, where a beginning of each cluster of IM pilots is separated by a distance d=Nsd/2 for input to the LDPC tone mapper. In other selected embodiments, the input IM pilot design includes four clusters of IM pilots, each having an output subcarrier index having a specified offset value, where a beginning of successive clusters of IM pilots are separated by a distance d=Nsd/4 for input to the LDPC tone mapper. In other selected embodiments, the input IM pilot design includes a first cluster of IM pilots and a second cluster of IM pilots, where a beginning of the first cluster of IM pilots is separated from a beginning of the second cluster of IM pilots by a distance d=Nsd/2 for input to the LDPC tone mapper, and where the first and second clusters of IM pilots each have a specified offset value, where the first cluster of IM pilots has adjacent IM pilot tones, and where the second cluster of IM pilots has alternating IM pilot tones. In selected embodiments of the first wireless device, the specified offset value can be introduced at an input or an output of the LDPC tone mapper.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner. It should also be noted that at least some of the operations for the methods described herein may be implemented using software instructions stored on a computer useable storage medium for execution by a computer. As an example, an embodiment of a computer program product includes a computer useable storage medium to store a computer readable program. The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD). Alternatively, embodiments of the invention may be implemented entirely in hardware or in an implementation containing both hardware and software elements. In embodiments which use software, the software may include but is not limited to firmware, resident software, microcode, etc.

Although the described exemplary embodiments disclosed herein are directed to a wireless communication station (STA) devices which use input interference mitigation (IM) pilot designs having one or more IM pilot clusters to generate PPDUs with distributed IM pilots in selected 802.11bn-compliant wireless connectivity applications and methods for operating same, the present invention is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements or pilot/data tone index values may be used in order. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A wireless communication method for generating IM pilot subcarriers by a first wireless device, comprising:
providing one or more interference mitigation (IM) pilot spacing input parameters to a Low-Density Parity-Check (LDPC) tone mapper, where the one or more IM pilot spacing input parameters specify an input IM pilot design with a plurality of IM pilots that are grouped into one or more clusters of IM pilots and specify an offset value for each cluster of IM pilots;
generating a Physical Layer Protocol Data Unit (PPDU) that includes a resource unit (RU) or multi-RU (MRU) with all tones distributed over a spreading frequency block, wherein the LDPC tone mapper processes the one or more IM pilot spacing parameters to identify a disjoint set of IM pilot subcarriers corresponding to the plurality of IM pilots, the disjoint set of IM pilot subcarriers being substantially uniformly spaced within the RU or MRU; and
transmitting the PPDU in the spreading frequency block by using the disjoint set of IM pilot subcarriers.

2. The wireless communication method of claim 1, wherein transmitting the PPDU comprises transmitting the PPDU using Orthogonal Frequency-Division Multiple Access (OFDMA).

3. The wireless communication method of claim 1, wherein each cluster of IM pilots has a different offset value.

4. The wireless communication method of claim 1, wherein the offset value is applied to the output subcarrier index of the LDPC tone mapper.

5. The wireless communication method of claim 1, wherein the one or more IM pilot spacing input parameters specify that the input IM pilot design includes a single IM pilot cluster which contains the plurality of IM pilots.

6. The wireless communication method of claim 1, wherein the one or more IM pilot spacing input parameters specify that the input IM pilot design includes a first IM pilot cluster and a second IM pilot cluster which is separated from the first IM pilot cluster by a first separation distance Nsd/2, where Nsd is a specified number of data subcarriers in an Orthogonal Frequency-Division Multiplexing (OFDM) symbol.

7. The wireless communication method of claim 1, wherein the one or more IM pilot spacing input parameters specify that the input IM pilot design includes a first IM pilot cluster, a second IM pilot cluster, and a third IM pilot cluster, where the first IM pilot cluster and second IM pilot cluster are separated by a separation distance Nsd/3, and where the second IM pilot cluster and third IM pilot cluster are separated by the separation distance Nsd/3.

8. The wireless communication method of claim 1, wherein the one or more IM pilot spacing input parameters specify that the input IM pilot design includes a first IM pilot cluster, a second IM pilot cluster, a third IM pilot cluster, and a fourth IM pilot cluster, where the first and second IM pilot clusters are separated by a separation distance Nsd/4, where the second and third IM pilot clusters are separated by the separation distance Nsd/4, and where the third and fourth IM pilot clusters are separated by the separation distance Nsd/4.

9. The wireless communication method of claim 5, wherein the one or more IM pilot spacing input parameters specify that the input IM pilot design may use 17 IM pilots for 106 RU, or may use 52 or 26 IM pilots for 20 MHz (242 RU), or may use 39 or 78 IM pilots for 40 MHz (484 RU), or may use 49 or 98 or 147 or 196 IM pilots for 80 MHz (996 RU), or may use 16 IM pilots for 52 RU, or may use 18 IM pilots for 52+26 RU, or may use 21 IM pilots for 106+26 RU, or may use 39 IM pilots for 484+242 RU.

10. The wireless communication method of claim 6, wherein the one or more IM pilot spacing input parameters specify that the input IM pilot design may use 34 IM pilots for 106 RU, or may use 52 IM pilots for 20 MHz (242 RU), or may use 78 IM pilots for 40 MHz (484 RU), or may use 196 IM pilots for 80 MHz (996 RU), or may use 78 IM pilots for 484+242 RU, or may use 278 IM pilots for 484+484 RU.

11. The wireless communication method of claim 7, wherein the one or more IM pilot spacing input parameters specify that the input IM pilot design may use 117 IM pilots for 484+242 RU.

12. The wireless communication method of claim 8, wherein the one or more IM pilot spacing input parameters specify that the input IM pilot design may use 196 IM pilots for 80 MHz (996 RU) or may use 156 IM pilots for 484+484 RU.

13. The wireless communication method of claim 1, wherein generating the PPDU comprises defining an updated number of data subcarriers parameter (Nsd, short_updated) as Nsd, short−Nim/4, where Nim specifies a count of the plurality of IM pilots, and where Nsd, short specifies a count of data subcarriers available for the transmission of data bits within the last OFDM symbol for a given “pre-FEC padding factor” value.

14. The wireless communication method of claim 13, wherein the updated number of data subcarriers parameter (Nsd_short_update) specifies that 8 tones or 12 data tones are used for the IM pilot designs which have, respectively, 16 IM pilot tones and 8 IM pilot tones for 52 RU.

15. The wireless communication method of claim 13, wherein the updated number of data subcarriers parameter (Nsd_short_update) specifies that 12 tones or 18 data tones are used for the IM pilot designs which have, respectively, 17 IM pilot tones and 34 IM pilot tones for 52+26 RU.

16. The wireless communication method of claim 13, wherein the updated number of data subcarriers parameter (Nsd_short_update) specifies that 18 tones or 12 data tones are used for the IM pilot designs which have, respectively, 18 IM pilot tones and 9 IM pilot tones for 106 RU.

17. The wireless communication method of claim 13, wherein the updated number of data subcarriers parameter (Nsd_short_update) specifies that 24 tones are used for the IM pilot designs which have 21 IM pilot tones for 106+26 RU.

18. The wireless communication method of claim 13, wherein the updated number of data subcarriers parameter (Nsd_short_update) specifies that 48 tones or 54 data tones are used for the IM pilot designs which have, respectively, 52 IM pilot tones and 36 IM pilot tones for 242 RU.

19. The wireless communication method of claim 13, wherein the updated number of data subcarriers parameter (Nsd_short_update) specifies that 102 tones or 108 data tones are used for the IM pilot designs which have, respectively, 78 IM pilot tones and 39 IM pilot tones for 484 RU.

20. The wireless communication method of claim 13, wherein the updated number of data subcarriers parameter (Nsd_short_update) specifies that 168, 162 and 150 data tones are used for the IM pilot designs which have, respectively, 39, 78 and 117 pilot tones for 484+242 RU.

21. The wireless communication method of claim 13, wherein the updated number of data subcarriers parameter (Nsd_short_update) specifies that 228, 216, 204 and 192 data tones are used for the IM pilot designs which have, respectively, 49, 98, 147 and 196 pilot tones for 996 RU.

22. A first wireless device comprising:
a plurality of wireless transceivers;
memory including operational instructions; and
one or more processing modules operably coupled to the plurality of wireless transceivers and the memory,
wherein the one or more processing modules are configured to execute the operational instructions to generate IM pilot subcarriers by:
providing one or more interference mitigation (IM) pilot spacing input parameters to a Low-Density Parity-Check (LDPC) tone mapper, where the one or more IM pilot spacing input parameters specify an input IM pilot design with a plurality of IM pilots that are grouped into one or more clusters of IM pilots and specify an offset value for each cluster of IM pilots;
processing the one or more IM pilot spacing input parameters at the LDPC tone mapper to assign the plurality of IM pilots to a disjoint set of IM pilot subcarriers that are substantially uniformly spaced from one another;
generating a Physical Layer Protocol Data Unit (PPDU) that includes a resource unit (RU) with all data and IM pilot tones distributed over a spreading frequency block which includes the disjoint set of IM pilot subcarriers corresponding to the plurality of IM pilots, the disjoint set of IM pilot subcarriers being substantially uniformly spaced from one another; and
transmitting the PPDU in the spreading frequency block by using the disjoint set of IM pilot subcarriers.

23. The first wireless device of claim 22, wherein the input IM pilot design includes a single cluster of IM pilots with an output subcarrier index having a specified offset value, where the single cluster of IM pilots is appended at a beginning or an end of a plurality of data tones for input to the LDPC tone mapper.

24. The first wireless device of claim 22, wherein the input IM pilot design includes two clusters of IM pilots, each having an output subcarrier index having a specified offset value, where a beginning of each cluster of IM pilots is separated by a distance d=Nsd/2 for input to the LDPC tone mapper, where Nsd is a specified number of data subcarriers in an Orthogonal Frequency-Division Multiplexing (OFDM) symbol.

25. The first wireless device of claim 22, wherein the specified offset value is introduced at an input or an output of the LDPC tone mapper, and
wherein the input IM pilot design:
includes three clusters of IM pilots, each having an output subcarrier index having a specified offset value, where successive clusters of IM pilots have beginnings that are separated by a distance d=Nsd/3 for input to the LDPC tone mapper, or
includes four clusters of IM pilots, each having an output subcarrier index having a specified offset value, where successive clusters of IM pilots have beginnings that are separated by a distance d=Nsd/4 for input to the LDPC tone mapper, or
includes a first cluster of IM pilots and a second cluster of IM pilots, where a beginning of the first cluster of IM pilots is separated from a beginning of the second cluster of IM pilots by a distance d=Nsd/2 for input to the LDPC tone mapper, and where the first and second clusters of IM pilots each have a specified offset value, where the first cluster of IM pilots has adjacent IM pilot tones, and where the second cluster of IM pilots has alternating IM pilot tones.
